(19) United States
(12) Patent Application Publication
(10) Pub. No.: US 2022/0139363 A1
(43) Pub. Date: May 5, 2022

(54) Conversion of Music Audio to Enhanced MIDI Using Two Inference Tracks and Pattern Recognition

(71) Applicant: New Resonance, LLC, Mountain View, CA (US)

(72) Inventor: John Fargo Lathrop, Mountain View, CA (US)

(73) Assignee: New Resonance, LLC, Mountain View, CA (US)

(21) Appl. No.: 17/507,740

(22) Filed: Oct. 21, 2021

Related U.S. Application Data
(60) Provisional application No. 63/108,319, filed on Oct. 31, 2020.

(51) Int. Cl. G10H 1/00; G10H 1/02; G10G 1/04

(52) U.S. Cl. CPC G10H 1/0025; G10G 1/04; G10H 1/02; G10H 1/0066

(57) ABSTRACT

A method and system for automatically transcribing an audio source, e.g. a WAV file or live feeds, into a computer-readable code, e.g., enhanced MIDI, are provided, specifically and limited to solving a central problem that has not been solved elsewhere: it takes a large sampling window, say from a fifth of a second to a full second for typical music, to extract many music perceptual parameters of interest, yet that transcription also needs to maintain synchronization with the source music, with the time resolution of that synchronization about a sixteenth of a second.

### RELATED APPLICATIONS

This application claims priority to provisional patent application 63/108,319 filed on Oct. 31, 2020.

### FIELD OF THE DISCLOSURE

This disclosure relates generally to automatic music transcription (AMT), and more particularly to AMT to generate visual representations of music.

### BACKGROUND

Visualization of music, such as described for example in U.S. Pat. No. 10,978,033 B2 issued on Apr. 13, 2021, entitled Mapping Characteristics Of Music Into A Visual Display, can be highly beneficial. For most music visualization and in particular for the technology described in that patent, it is important to characterize each note in terms of any of many attributes, e.g., pitch, amplitude over time including attack and decay, nature of the attack other than amplitude over time (e.g., timbre specifically of the attack), timbre, vibrato, tremolo, being part of a strum, and/or being part of a chord. Those attributes call for a long sampling time, e.g. a fifth of a second to a whole second, yet it is important to identify each note precisely where it starts (“onset”), often with a time resolution equal to the human perceptual limit of event timing, about a 16^{th} of a second. How, then, to meet those two seemingly conflicting requirements of time resolution and sampling time? This is a particular challenge when a visualization application calls for processing time to keep up with a time-streaming musical source in real time or near real time, or in a process suited to automation.

Interestingly, the above-noted problem does not appear to be adequately addressed in the patent literature. European Pat. No. 2,115,732 to Taub addresses analysis of frequency and amplitude to detect note onset events, then by examining data from each note onset event other data (envelope, timbre, pitch, dynamic data and other data) are generated, then from sets of note onset events further data are generated. But that all involves a multi-step signal processing process, much longer processing time than real time or near real time, and so nothing there addresses the problem as described above of time resolution vs. sampling time.

U.S. Pat. No. 9,779,706 to Cogliati describes an AMT approach limited to piano and based on a pre-recorded dictionary of piano note waveforms, one waveform for each key of the piano, in fact including not only the particular piano generating the music being analyzed, but also optionally that pre-recording conducted in the specific environment where the piano performance is to be performed. Clearly, Cogliati's approach is not amenable to AMT for general music sources.

Japan Pat. No. 2008518270 describes an approach where the music signal is analyzed into N frequency domain representations of the audio signal over time, one for each pitch, then a note is detected by selecting the best matching time domain representation. The patent includes variations on that method. While describing an interesting approach to note detection, it is based on a multi-step signal processing process and offers no way to capture the several characteristics of each note listed earlier.

U.S. Pat. No. 8,541,66 to Waldman creates hundreds of samples of notes and instruments, each of those for three different levels of force, then splitting those samples between attack and sustain, then comparing the song to that sample set to find the best matches (coherence values) and matches attack and sustain samples. Again, an interesting approach to AMT, but again, a multi-step process, and not at all applicable to the time resolution—sampling time problem presented above.

Turning to the non-patent literature, there do not appear to be any adequate solutions that address the time resolution—sample time problem described above. The closest appears to be work by Hawthorne et al at the Google Brain Team, described in Onsets and Frames: Dual-Objective Piano Transcription, 19^{th} International Society for Music Information Retrieval Conference, Paris, France, 2018 [1]. Hawthorne et al describe a signal processing system that separately detects note onsets and notes (with durations), then conditions the detected notes on corresponding note onsets, i.e., only recognizes detected notes if they have a corresponding detected onset. But their system is limited to piano, so that timbre is set, and recognizes no characteristics of each note with duration except simply its pitch and duration.

As seen from the foregoing, there remains a need for a solution that addresses the above-noted time resolution—sampling time challenge in generating automatic music transcriptions and visualizations.

### SUMMARY

Embodiments of the invention solve a central problem in Automatic Music Transcription, AMT: The sampling time called for to extract elements of the audio signal, e.g., recognizing a note and its timbre, may be from a fifth of a second to a full second for typical music. Yet the time resolution called for to recognize such things as note onset and attack timbre for some transcribed music may be at the limit of human perception discriminating events in time, about a sixteenth of a second. Embodiments of the invention solve that problem by dividing the audio signal into two tracks, Track 1 in real time and Track 2 delayed. Track 1 is analyzed to infer information that can be used to identify onset time and aspects of the note attack such as its timbre, and other characteristics of a note when applied as filters to each note as it is observed in Track 2. The words “filter,” “applied as filters,” etc. are used here as abbreviations for what could be a sophisticated signal processing process that makes use of Track-1 information to analyze the note as it is received in delayed form in Track 2.

Additional aspects related to the invention will be set forth in part in the description that follows, and in part will be apparent to those skilled in the art from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques.

FIG. 1 provides high level overview to explain the logic of the two-track structure employed by embodiments of the invention, presented in a “piano roll” format, with an analyzed musical note progressing from left to right over time.

FIG. 2 provides an equivalent high-level overview, though in this case in the format of a computer operation flowchart.

FIG. 3 is a block diagram of computer hardware that may be employed in certain embodiments of computer systems described herein.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

The technology described herein, which we call “Two-Track AMT,” is a valuable new process to assist in Automatic Music Transcription, AMT. AMT is an automated process that starts with an audio track (file, etc., e.g., a WAV file, or a live feed) of a piece of music, and transcribes that into a computer-readable rendition of that music, e.g., MIDI code or enhancements of MIDI code. AMT is a critical, central step in any audio-to-music-score software, and music visualization technology. It involves sophisticated signal processing and is quite challenging in several ways, as described in Benetos et al [2]. For reasons explained below, Two-Track AMT is particularly suited for music visualization. It is particularly suited to the music visualization process described in the above noted U.S. Pat. No. 10,978,033, entitled Mapping Characteristics of Music Into a Visual Display, which we abbreviate here “PAMVis” for Psychoacoustic Music Visualization.

Technology such as PAMVis depends upon an automated process to identify any of several characteristics of each musical note, e.g., pitch, amplitude over time including attack and decay, nature of the attack other than amplitude over time (e.g., timbre specifically of the attack), timbre, vibrato, tremolo, being part of a strum, being part of a chord, and any other characteristics found to be of interest. Other aspects of music visualization, e.g., tension-release, follow from the set of all notes being played, and so follow from the initial note-characterization step. Timbre may include determining whether one instrument or many are playing the same note (e.g., one violin vs. a 20-violin section), sibilance, and discriminating between e.g., a violin and a viola. Many of the characteristics listed here require a significant sampling time before they can be characterized, e.g., from a fifth of a second to a full second for typical music.

Described herein is a signal processing technology that converts an audio music signal, either live or for example a WAV file, to enhanced MIDI in a pronounced improvement over current AMT technology. By enhanced MIDI I mean a computer code representation of audio music where each note is characterized by any of the attributes listed in the above, namely: pitch, amplitude over time including attack and decay, nature of the attack other than amplitude over time (e.g. timbre specifically of the attack), timbre, vibrato, tremolo, being part of a strum, being part of a chord, and any other characteristics found to be of interest. Enhanced MIDI encodes all the information to be subsequently used in further stages of the PAMVis or equivalent music visualization technology to 1) extract from enhanced MIDI some or many psychoacoustic cues important to human music perception; 2) convert those cues to corresponding visual cues, using a mapping selected perhaps by a user; then 3) assemble those visual cues into a perceptually effective time-streaming visual display.

The technology described here does that by mimicking how I posit that humans perceive music. Current AMT technology, best represented by Hawthorne [1], directly extracts descriptive parameters from the audio wave form. But in fact, humans don't do that directly. Rather, I posit, they first recognize notes in a pattern-recognition paradigm, and then from those recognized notes they recognize all other aspects of music perception for each note, including the time of note onset and attack, even though note onset and attack will have occurred before a human completes his or her recognition of the note with all of its perceived aspects. That process would seem to involve “going backward in time,” a seeming impossibility, but humans do it simply by buffering information on each note and updating that information with further perceptual analysis.

Translating that concept into signal processing, that can be described as a two-track process:

Track 1: Works with a sliding sampling window, duration varying from about one fifth second to a full second, to recognize notes and one or more of the characteristics of each note listed earlier: pitch, amplitude over time including attack and decay, nature of the attack other than amplitude over time (e.g. timbre specifically of the attack), timbre, vibrato, tremolo, being part of a strum, being part of a chord, and any other characteristics found to be of interest). That recognition and characterization can be applied to Track 2 in the form of filters as defined earlier.

Track 2: is delayed by at least the duration of the sliding sample window of Track 1. Track 2 works with each of those recognized notes, taking advantage of the delay of Track 2 to effectively work backward in time to apply the filters developed based on Track 1: to detect onset time (when the recognized note rose out of the noise), measure amplitude over time of that note back to onset (and so measure attack amplitude profile), coupling that with the amplitude over time of the rest of the extent of the recognized note, characterize the timbre of the attack, and characterize the note in other ways such as listed earlier. The delay of Track 2 can be adjusted to the nature of the music and the relationship between that delay and the application of the AMT.

Track 2 can work at the time resolution of human event perception, about 16 Hz. The two tracks work together with a time delay set by the sliding-window time of Track 1. Again, I posit that this 2-track process effectively mimics processes in human music perception.

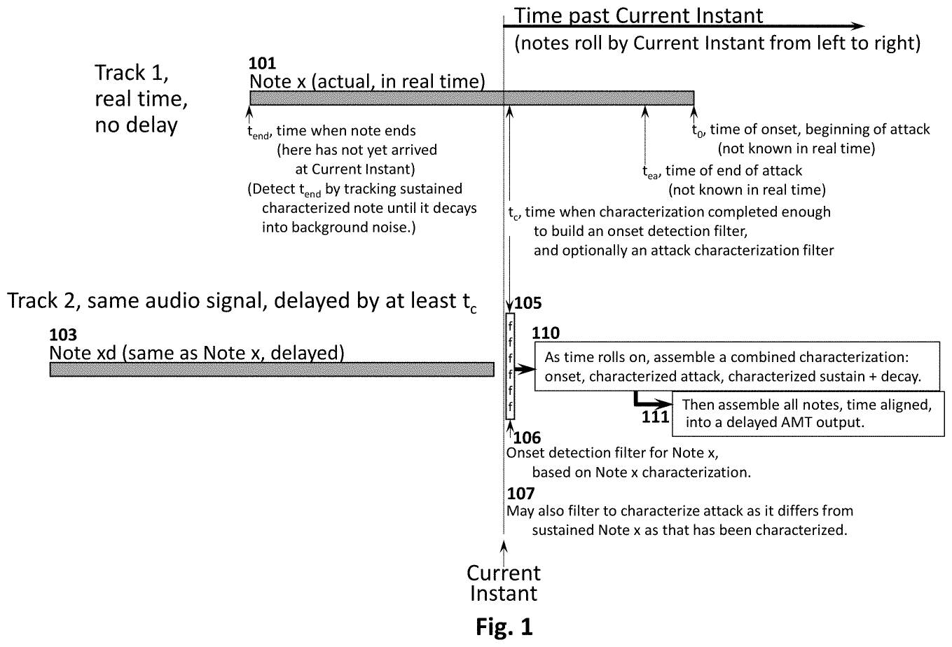

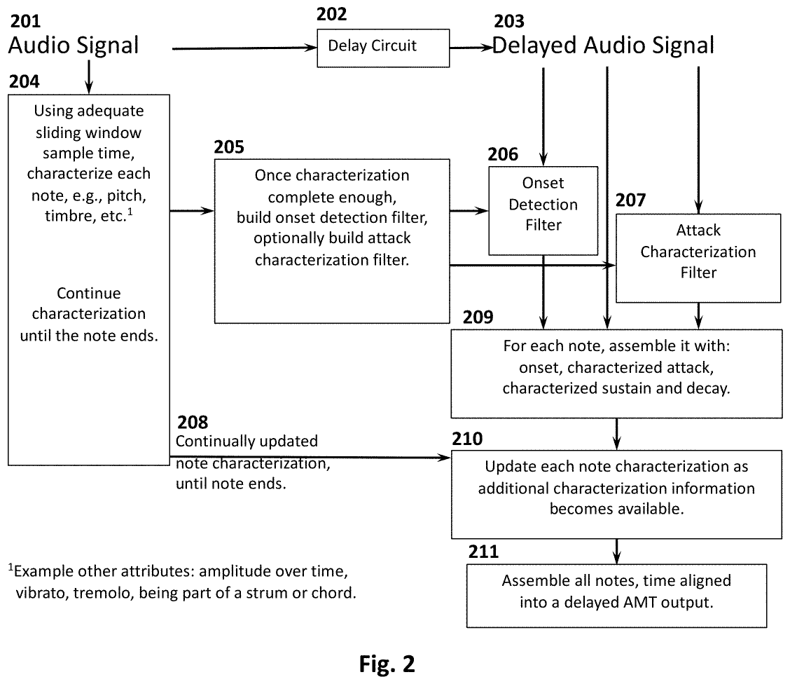

The logic of this two-track approach may not be clear at first. It seems that the system builds a filter to detect onset time and optionally to characterize the attack period as different from the sustain period, then “goes backward in time” to apply those filters to the attack portion of each note. We explain those operations here in FIGS. 1 and 2, from each of two different perspectives.

FIG. 1 presents the logic implemented by embodiments of the invention in a “piano roll” format, with an analyzed musical note progressing from left to right over time. The top gray bar, 101, represents a note in real time, extending over the x axis of the figure as it rolls along in real time. It has four time events of interest. t₀, time of onset, is the beginning of the attack of the note, though we don't recognize that in real time because of difficulties in detecting that event in the complexity of most music. tₑₐ, time of end of the attack, is when the note's timbre shifts from the attack timbre to the sustain timbre. Again, we don't recognize that in real time because of difficulties in detecting that event in the complexity of most music. t_{c} is the time when the system has analyzed the note for long enough to build an onset detection filter and, optionally, an attack characterization filter, i.e., a filter that allows the system to determine the attack amplitude gain and timbre as it differs from the amplitude over time and timbre of the sustained part of the note. Finally, t_{end} is the time when the note ends, i.e., when the system tracks the sustain part of the note until it decays into background noise.

Of those four time events, from an operational point of view the most important time is t_{c}. That is when the system has accumulated enough information about the note to build two types of filters (105): onset detection filter(s) for that note, based on its characterization of that note (106), and attack characterization filter(s) for that note, based on how the attack differs from the sustain part of the note (107). But of course, those two events, note onset and note attack, have already happened in the past, in real time. We solve that problem by applying those filters to the same note but delayed (103). (Numbering of the parts of FIG. 1 is selected to match corresponding events in FIG. 2, and so are out of sequence in this explanation of FIG. 1.) So then in operation 110 the system can combine the delayed note's characterization over time with the filter(s) to generate an assembled characterization of the note: onset, characterized attack, characterized sustain and decay. Finally, in operation 111 the system can assemble all characterized notes, time aligned into a complete music transcription.

FIG. 2 presents the same logic of the embodiment shown in FIG. 1, but in the format of a computer operation flowchart. In that format we are able to present some operations not presented in FIG. 1. We start with the audio signal, 201, and feed that through a delay circuit 202 to generate a delayed signal 203. That sets up the top and bottom halves of FIG. 1. Then the system uses an adequate, perhaps as long as one full second or more, sliding window sample time to characterize each note 204. As the system accumulates information on each note, at some point (t_{c} of FIG. 1) it has enough information to build onset detector filter(s) and optionally attack characterization filter(s) 205. It can then apply onset detection filter(s) to the delayed signal 206, and apply attack characterization filter(s) to the delayed signal 207. With those filters applied, the system can assemble a combined characterization of the delayed note: onset, characterized attack, characterized sustain and decay 209. But a key fact not explained in FIG. 1: The system can continue to improve its characterization of the note after t_{c}, 208 and feed that continually improving characterization in to updating the assembled characterization of the note 210. Finally, the system can assemble all updated characterized notes time aligned into a complete transcription of the music 211.

In applications where the AMT must occur in near real time, the audio signal can be fed into a delay circuit, then delivered to the joint audio-visualization output system synchronized with the delayed visualization signal. In applications where the AMT must occur in real time, e.g. in concerts, the delay must be limited to less than what would be a delay that would be annoyingly out of synch with the audio signal as perceived by the audience. Those cases then have a limitation on the length of the sliding sample window, but those applications can involve assists in the AMT since timbre and note separation operations can make use of different mic feeds into the system.

The length of the sliding sample window can be optimized to the music subject to the acceptable delay in the application. Applications where large delays are acceptable, with the audio signal delayed to synchronize with the delayed AMT-based signal, can enjoy the better AMT performance of that longer sliding sample window.

To achieve the best performance, the two tracks can each work in pattern recognition mode. The key advantage of pattern recognition is to make the best use of information characterizing the patterns to be recognized. In this case the two tracks run in pattern recognition mode based on two different pattern sets:

Track 1 pattern recognition takes advantage of the fact that, in western music, notes occur at one of 88 pitches. (A special piano has 97 pitches but is seldom used.) Non-discrete-pitch glissandos, portamentos and between-pitch notes can be addressed as special patterns. That raises the possibility of a comb filter paradigm. Then also, in western music timbres fall into roughly 35 categories, though it isn't clear that discriminating among all 35 timbres is critical for music perception. The nature of those 35 timbres, e.g., strings, woodwinds, brass, etc., lends itself to smaller numbers of timbres as timbre categories. Every well-known vocal soloist has his or her unique timbre, and those unique timbres could be loaded into the pattern recognition paradigm as an option, but music visualization does not have to visually present those “personal timbres.”

Track 2 pattern recognition takes advantage of a discrete set of common attacks and decays, such that a complete per-application transcription of attacks and decays is not necessary.

In summary, the disclosed technology divides audio-to-enhanced-MIDI conversion into two tracks:

1) One track recognizing notes and any of several characteristics of each note, e.g., pitch, amplitude over time including attack and decay, nature of the attack other than amplitude over time (e.g., timbre specifically of the attack), timbre, vibrato, tremolo, being part of a strum, being part of a chord, and any other characteristics found to be of interest, optionally applying pattern recognition based on a set number of combinations of those characteristics, based on a sliding-window sampling with the length of that window set by the nature of the music and the time-delay constraints of the application;

2) A second track working on each of those recognized notes after they are recognized, taking advantage of the delay of the second track to work backward over time to recognize its onset time, amplitude over time of its attack and attack timbre, and any other such characteristics of interest, applying pattern recognition based on a set number of attacks and decays, based on a time resolution matching human music event time resolution of about 16 Hz.

The two tracks work together, with a time delay set by the sliding-window time length of the first track. That delay either removed by delaying the audio signal to match the AMT signal or is tolerated in applications that must operate in real time, e.g., concerts.

The embodiments herein can be implemented in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

The terms “computer system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

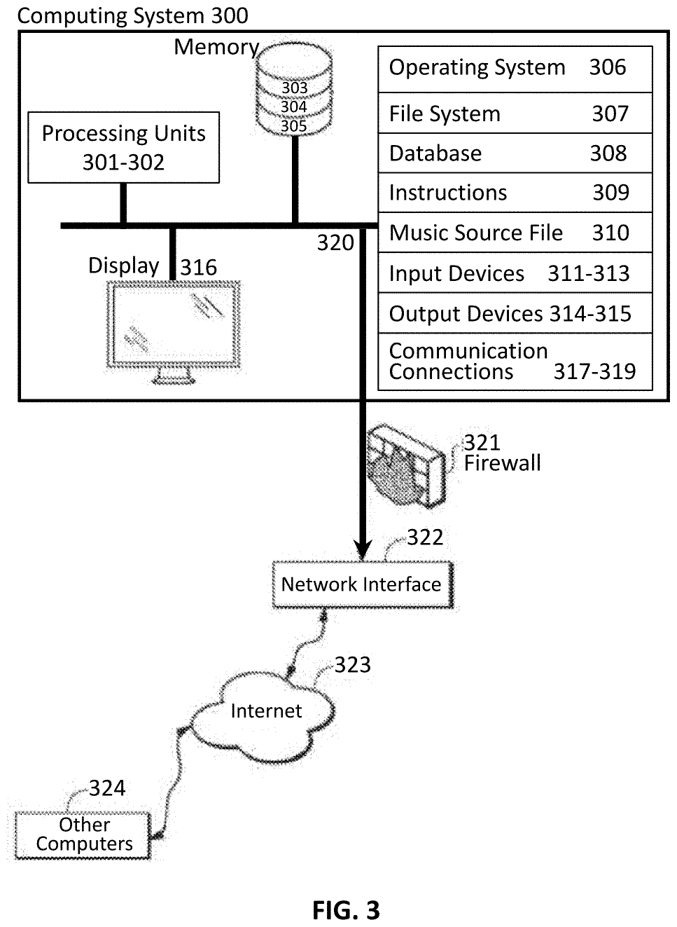

FIG. 3 depicts a generalized example of a suitable general-purpose computing system 300, in which the described innovations may be implemented. With reference to FIG. 3 the computing system 300 includes one or more processing units 301, 302 and memory or tangible storage 303, 304, 305. The processing units 301, 302 execute computer-executable instructions. A processing unit can be a general-purpose central processing unit (CPU), processor in an application-specific integrated circuit (ASIC) or any other type of processor. The memory 303, 304, 305 may be volatile memory (e.g., registers, cache, RAM), non-volatile memory (e.g., ROM, EEPROM, flash memory, etc.), or some combination of the two, accessible by the processing unit(s). The hardware components in FIG. 3 may be standard hardware components, or alternatively, some embodiments may employ specialized hardware components to further increase the operating efficiency and speed with which the computing system 300 operates. The various components of computing system 300 may be rearranged in various embodiments, and some embodiments may not require nor include all of the above components, while other embodiments may include additional components, such as specialized processors and additional memory.

Computing system 300 will or may have additional features such as for example, an operating system 306, file system 307, database 308, instructions 309, Music Source File 310, one or more input devices 311-313, one or more output devices 314-315 including a display 316, and one or more communication connections 317-319. An interconnection mechanism 320 such as a bus, controller, or network interconnects the components of the computing system 300. Typically, operating system software provides an operating system for other software executing in the computing system 300, and coordinates activities of the components of the computing system 300.

The memory 303-305 may be removable or non-removable, and includes flash memory, magnetic disks, magnetic tapes or cassettes, CD-ROMs, DVDs, nonvolatile random-access memory, or any other medium that can be used to store information in a non-transitory way and that can be accessed within the computing system 300. The memory 303-305 stores instructions for the software implementing one or more innovations described herein.

The input device(s) 311-313 may be a touch input device such as a keyboard, mouse, pen, or trackball, a voice input device, a music input device, a scanning device, or another device that provides input to the computing system 300. For video encoding, the input device(s) 311-313 may be a camera, video card, TV tuner card, or similar device that accepts video input in analog or digital form, or a CD-ROM or CD-RW that reads video samples into the computing system 300. The output device(s) 314-316 may be a monitor, printer, speaker, CD-writer, or another device that provides output from the computing system 300.

The communication connection(s) 317-319 enable communication over a communication medium to another computing entity, for example through a firewall 321, network interface 322, then the Internet 323 to other computers 324. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The embodiments described herein may be employed, by way of example, to implement a method of automatic music transcription (AMT) that may include applications for music visualization, designed to detect note onset, extract attack characteristics, and extract other characteristics characterizing each note in time periods too early in each note arrival to be detected and characterized in real time as the note arrives due to sampling time considerations. The method may include the following operations: (a) establishing a two-track analysis system where the incident audio music source is divided into Track 1, the music with no delay; and Track 2, the same music source delayed by an amount necessary for successful execution of the operations described in (b), (c), and (d) below; (b) analyzing Track 1 with an adequate sliding window sampling time to characterize each note in attributes of interest to the transcription, e.g. one or more of pitch, timbre (of both the attack and the sustain part of each note), amplitude over time, vibrato, tremolo, being part of a strum or chord, or other characteristics that characterization improving over time as the sampled time of each note increases; (c) once characterization of each note has reached an adequate level, development of one or more of onset detection filters, attack characterization filters, and other characterization filters of note characteristics occurring too early in each note arrival to be detected and characterized in real time; (d) applying those filters to the delayed Track 2 in signal processing to extract the note characterization information for which each filter is designed; (e) for each note, assembling all of its note characterization information into a time coherent representation of all extracted note characterization information of that note, adequate for transcription including in some applications for music visualization; and (f) assembling all note characterization information into a time aligned characterization of all of the notes of the musical piece, adequate for transcription including in some applications for music visualization.

In a further aspect the foregoing method may also include, in the noted applications, where the transcription or visualization can occur in delayed real time, the audio signal can be fed both into the analysis process described above, and separately into a delay circuit, delayed such that the audio signal can then be combined time aligned with the product described above, such that no delay is perceived in that combined output.

In another aspect, in applications where the transcription or visualization must occur in real time, e.g., in concerts, the delay time involved in the process described above must be limited to one that results in a less then perceptually annoying delay between the transcription or visualization and the real time arrival of the audio music. That limitation may result in less than optimal characterizations, as a tradeoff with the limitations of the real time application.

In another aspect, the sliding window sampling time described in (b) above is adjusted to be optimized with respect to the analysis described in the AMT described above as a function of the nature of the particular music, that sampling time adjusted to constraints of the application described in the foregoing paragraph, that sampling time adjusted either manually or by a developed algorithm.

In another aspect, the analysis described in operation (b) of the AMT described above is continued after applying its results to filter development as described in operation (c) to develop note characterization information to be applied to continually improve note characterization, updating that note characterization after application of the filters described in operation (d).

In another aspect, the analysis of (b) above includes pattern recognition based on known and developed patterns in music at the discrete note level, including but not limited to lists of pitches, timbres, note attacks and decays.

The embodiments described herein may be employed by way of example to implement a system for transcribing a piece of music, including applications for music visualization, wherein the system comprises: (a) a music source;

(b) a memory; (c) a processor, wherein the processor is configured to execute instructions stored in the memory, and wherein the instructions comprise instructions for: (i) establishing a two-track analysis system where the incident audio music source is divided into Track 1, the music with no delay; and Track 2, the same music source delayed by an amount necessary for successful execution of the operations described in (ii), (iii), and (iv) below; (ii) analyzing Track 1 with an adequate sliding window sampling time to characterize each note in attributes of interest to the transcription, e.g. one or more of pitch, timbre (of both the attack and the sustain part of each note), amplitude over time, vibrato, tremolo, being part of a strum or chord, or other characteristics that characterization improving over time as the sampled time of each note increases; (iii) once characterization of each note has reached an adequate level, development of one or more of onset detection filters, attack characterization filters, and other characterization filters of note characteristics occurring too early in each note arrival to be detected and characterized in real time; (iv) applying those filters to the delayed Track 2 in signal processing to extract the note characterization information for which each filter is designed; (v) for each note, assembling all of its note characterization information into a time coherent representation of all extracted note characterization information of that note, adequate for transcription including in some applications for music visualization; and (vi) assembling all note characterization information into a time aligned characterization of all of the notes of the musical piece, adequate for transcription including in some applications for music visualization.

The system described above may also employ additional aspects as described above in connection with the above-described method of AMT.

It should be understood that functions/operations shown in this disclosure are provided for purposes of explanation of operations of certain embodiments. The implementation of the functions/operations performed by any particular module may be distributed across one or more systems and computer programs and are not necessarily contained within a particular computer program and/or computer system.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

### REFERENCES

Hawthorne, C., E. Eisen, J. Song, A. Roberts, I. Simon, C. Raffel, J. Engel, S. Oore, D. Eck (at the Google Brain Team), Onsets and Frames: Dual-Objective Piano Transcription, 19^{th} International Society for Music Information Retrieval Conference, Paris, France, 2018 [1].

Benetos, E., S. Dixon, Z. Duan, S. Ewert, Automatic Music Transcription: An Overview, IEEE Signal Processing Magazine, Jan. 2019 [2].

What is claimed is:

1. A method of automatic music transcription (AMT), including applications for music visualization, designed to detect note onset, extract attack characteristics, and extract other characteristics characterizing each note in time periods too early in each note arrival to be detected and characterized in real time as the note arrives due to sampling time considerations, the method comprising:
(a) establishing a two-track analysis system where a provided audio music source is divided into Track 1, comprising music with no delay; and Track 2, comprising Track 1 delayed by an amount necessary for successful execution of the operations set forth in (b), (c), and (d) below; and
(b) analyzing Track 1 with an adequate sliding window sampling time to generate a characterization of each note in attributes of interest to AMT, the characterization comprising one or more of pitch, timbre, amplitude over time, vibrato, tremolo, being part of a strum or chord; and
(c) once characterization of each note has reached a predetermined level, developing one or more of onset detection filters, attack characterization filters, and other characterization filters of note characteristics occurring too early in each note arrival to be detected and characterized in real time; and
(d) applying those filters to the delayed Track 2 in signal processing to extract the note characterization information for which each filter is designed; and
(e) for each note, assembling all of its note characterization information into a time coherent representation of all extracted note characterization information of that note, adequate for transcription including in some applications for music visualization; and
(f) assembling all note characterization information into a time aligned characterization of all of the notes of the musical piece, adequate for transcription including in some applications for music visualization.

2. The method of claim 1, wherein in applications where the transcription or visualization occurs in delayed real time, the audio signal is fed both into operation (b) of claim 1, and separately into a delay circuit, delayed such that the audio signal can then be combined time aligned with the product of claim 1, such that no delay is perceived in that combined output.

3. The method of claim 1, wherein in applications where the transcription or visualization must occur in real time, e.g. in concerts, the delay time involved in the process described in claim 1 must be limited to one that results in a less then perceptually annoying delay between the transcription or visualization and the real time arrival of the audio music. That limitation may result in less than optimal characterizations, as a tradeoff with the limitations of the real time application.

4. The method of claim 1, wherein the sliding window sampling time described in 1(b) is adjusted to be optimized with respect to the analysis described in claim 1 as a function of the nature of the particular music, that sampling time adjusted to constraints of the application described in claim 3, that sampling time adjusted either manually or by a developed algorithm.

5. The method of claim 1, wherein the analysis described in claim 1(b) is continued after applying its results to filter development as described in claim 1(c) to develop note characterization information to be applied to continually improve note characterization, updating that note characterization after application of the filters described in claim 1(d).

6. The method of claim 1, wherein the analysis of claim 1(b) includes pattern recognition based on known and developed patterns in music at the discrete note level, including but not limited to lists of pitches, timbres, note attacks and decays.
